(19) United States
(12) Patent Application Publication
(10) Pub. No.: US 2011/0170148 A1
(43) Pub. Date: Jul. 14, 2011

(54) INFORMATION PROCESSING APPARATUS, IMAGE FORMING APPARATUS WITH FACSIMILE FUNCTION, FACSIMILE TRANSMITTING METHOD, AND FACSIMILE TRANSMISSION PROGRAM

(75) Inventor: Shinya Nagano, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/986,250

(22) Filed: Jan. 7, 2011

Related U.S. Application Data
(60) Provisional application No. 61/294,153, filed on Jan. 12, 2010.

(51) Int. Cl. H04N 1/32

(52) U.S. Cl. 358/442

(57) ABSTRACT

According to one embodiment, an information processing apparatus includes: an acquiring unit configured to acquire instruction information for transmitting transmission target data by facsimile; a determining unit configured to determine, when the acquiring unit acquires the instruction information, whether information concerning a transmission destination is set; and a display unit configured to display, if the determining unit determines that information concerning a transmission destination is not set, a dialog for causing a user to set a transmission destination, the dialog including only items relating to information concerning transmission destinations.

### CROSS-REFERENCE TO RELATED APPLICATION

This application is also based upon and claims the benefit of priority from U.S. provisional application 61/294,153, filed on Jan. 12, 2010; the entire contents of which are incorporated herein by reference.

### FIELD

Embodiments described herein relate generally to an information processing apparatus related to transmission of a facsimile.

### BACKGROUND

There is a technique for transmitting electronic data such as document data or image data by facsimile by performing operation using a PC (Personal Computer).

In transmitting, via a facsimile driver, a facsimile job from an arbitrary application running on the PC, it is necessary to set information concerning a transmission destination such as a facsimile number or an address of an Internet facsimile.

When a user instructs transmission without setting information concerning a transmission destination, a facsimile driver in the past incorporated in a PC outputs a message indicating, for example, a transmission destination is unknown and forcibly cancels a facsimile transmission job. Some facsimile drivers always display, after receiving an instruction for facsimile transmission, a dialog in which setting items other than a transmission destination can be changed despite the fact that a function for setting resolution and other special functions are not used.

It is an object of an embodiment to realize convenience for a user by providing a technique for displaying, if information concerning a transmission destination is not set when a facsimile transmission job is output from an application via a facsimile driver, a dialog in which only information concerning the transmission destination can be set.

### DESCRIPTION OF THE DRAWINGS

FIG. 1 is a block diagram of a hardware configuration of an information processing apparatus;

FIG. 2 is a functional block diagram of the information processing apparatus;

FIG. 3 is a flowchart for explaining an operation example of the information processing apparatus;

FIG. 4 is a schematic diagram of a print dialog D1;

FIG. 5 is a schematic diagram of a destination designation dialog D2;

FIG. 6 is a block diagram of a hardware configuration of an image forming apparatus with facsimile function;

FIG. 7 is a functional block diagram of the image forming apparatus with facsimile function;

FIG. 8 is a flowchart for explaining an operation example of the image forming apparatus with facsimile function; and

FIG. 9 is a schematic diagram of a dialog D3.

### DETAILED DESCRIPTION

In general, according to one embodiment, an information processing apparatus includes: an acquiring unit configured to acquire instruction information for transmitting transmission target data by facsimile; a determining unit configured to determine, when the acquiring unit acquires the instruction information, whether information concerning a transmission destination is set; and a display unit configured to display, if the determining unit determines that information concerning a transmission destination is not set, a dialog for causing a user to set a transmission destination, the dialog including only items relating to information concerning transmission destinations.

An embodiment is explained below with reference to the accompanying drawings.

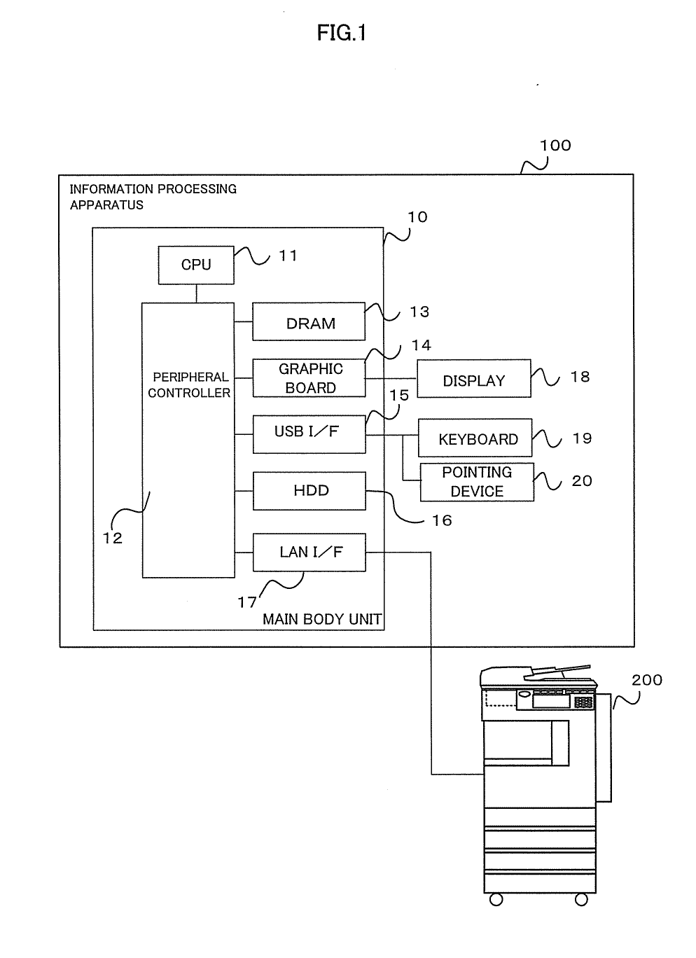

An example of a hardware configuration of an information processing apparatus necessary for carrying out this embodiment is shown in FIG. 1. An operation program for an information processing apparatus 100 is stored in a HDD (Hard Disk Drive) 16. A CPU (Central Processing Unit) 11 decodes and executes the operation program to control the information processing apparatus 100. The CPU 11 performs, using a DRAM (Dynamic Random Access Memory) 13, an arithmetic operation for executing the operation program.

A keyboard 19 and a pointing device 20 (e.g., a mouse) are connected to a main body unit 10 via a USB I/F (Interface) 15. A display 18 is connected to the main body unit 10 via a graphic board 14.

The information processing apparatus 100 is connected to a MFP (Multi Function Product) 200 having a facsimile transmission function via a LAN (Local Area Network) I/F 17. A peripheral controller 12 executes control of these kinds of hardware and various I/O ports.

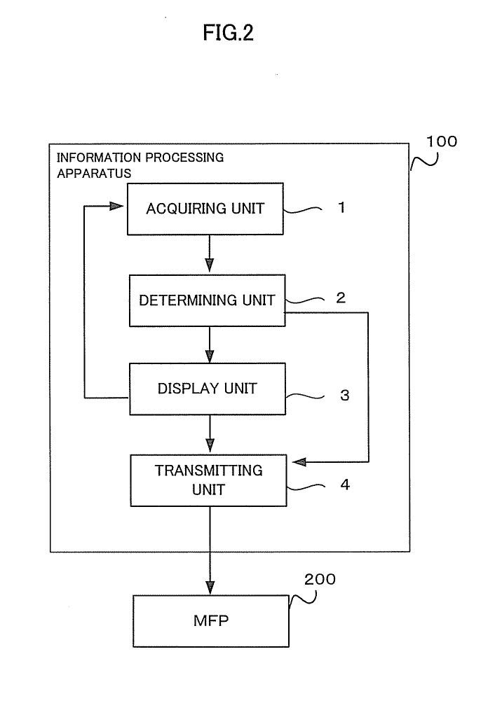

An example of functional blocks of the information processing apparatus 100 is shown in FIG. 2. The information processing apparatus 100 includes an acquiring unit 1, a determining unit 2, a display unit 3, and a transmitting unit 4.

The acquiring unit 1 acquires, via the keyboard 19 or the pointing device 20, instruction information output when electronic data is transmitted by facsimile. When the acquiring unit 1 acquires the instruction information, the determining unit 2 determines whether information concerning a transmission destination such as a facsimile number of the transmission destination is set in the instruction information (whether information concerning a transmission destination is stored in the DRAM 13 or the HDD 16 and this system can recognize the information).

The display unit 3 displays, on the display 18, document data or image data stored in the HDD 16 or the DRAM 13 and displays, on the display 18, a dialog for causing a user to select to which printing apparatus the electronic data is output (hereinafter, print dialog). If the determining unit 2 determines that information concerning a transmission destination is not set, the display unit 3 displays, on the display 18, a dialog for causing the user to set a transmission destination, which is a destination designation dialog including only items relating to information concerning transmission destinations.

The transmitting unit 4 transmits, to the MFP 200, a facsimile transmission job including information concerning the transmission destination set via the dialog displayed by the display unit 3 and transmission target data. The MFP 200 acquires the facsimile transmission job and transmits the transmission target data to a facsimile apparatus of the transmission destination. If the information processing apparatus 100 is directly connected to a telephone network or if a computer program (a driver) for facsimile transmission is installed (i.e., the information processing apparatus 100 itself can perform facsimile transmission), the transmitting unit 4 directly transmits data to the facsimile apparatus of the transmission destination not via the MFP 200. In the case of the Internet facsimile, the information processing apparatus 100 itself can also perform facsimile transmission. Therefore, the transmitting unit 4 transmits data to a facsimile apparatus or a PC of a transmission destination via the LAN I/F 17.

Correspondence between the functional blocks shown in FIG. 2 and the hardware configuration shown in FIG. 1 is explained below. The acquiring unit 1 is realized by cooperation of the CPU 11, the peripheral controller 12, the USB I/F 15, the keyboard 19, the pointing device 20, the operation program stored in the HDD 16, and the DRAM 13. The determining unit 2 is realized by cooperation of the CPU 11, the DRAM 13, the peripheral controller 12, and the operation program stored in the HDD 16. The display unit 3 is realized by cooperation of the CPU 11, the graphic board 14, the display 18, the DRAM 13, the operation program stored in the HDD 16, and the peripheral controller 12. The transmitting unit 4 is realized by cooperation of the CPU 11, the DRAM 13, the peripheral controller 12, the LAN I/F 17, and the operation program stored in the HDD 16.

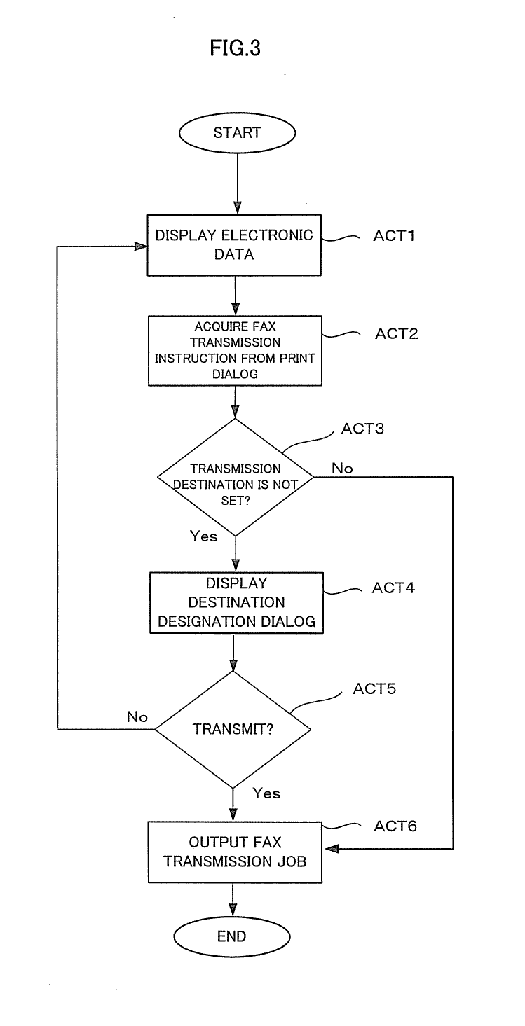

An operation example of the information processing apparatus 100 is explained below with reference to a flowchart of FIG. 3.

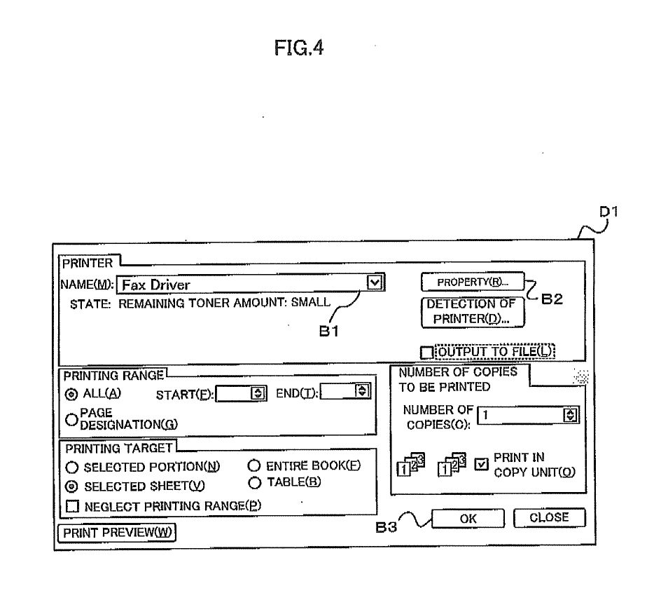

The display unit 3 displays electronic data such as document data or image data corresponding to an application started on the information processing apparatus 100 (ACT 1). The display unit 3 displays a print dialog D1 shown in FIG. 4 when facsimile transmission is performed.

The print dialog D1 is explained below. A user selects, using a pull-down menu B1 in the print dialog D1, an apparatus to which a facsimile can be output (in this example, it is assumed that the user selects the MFP 200). Subsequently, when the user presses a property button B2, a dialog in which information concerning transmission destinations such as facsimile numbers and special functions such as a function for setting resolution can be set (hereinafter referred to as property dialog) is displayed. As general operation, the property button B2 is rarely pressed. Unless the user is aware of the property button B2, after selecting an output target apparatus by operating the pull-down menu B1, the user instantaneously presses an OK button B3.

Referring back to the flowchart of FIG. 3, when the user presses the OK button B3 of the print dialog D1, the acquiring unit 1 acquires transmission instruction information (ACT 2).

When the acquiring unit 1 acquires the transmission instruction information, the determining unit 2 determines whether information concerning a transmission destination is set (ACT 3). If information concerning a transmission destination is set, i.e., if a facsimile number of the like of the transmission destination is set on the property dialog (No in ACT 3), the transmitting unit 4 outputs a facsimile transmission job including transmission data and transmission destination information to the MFP 20 (ACT 6).

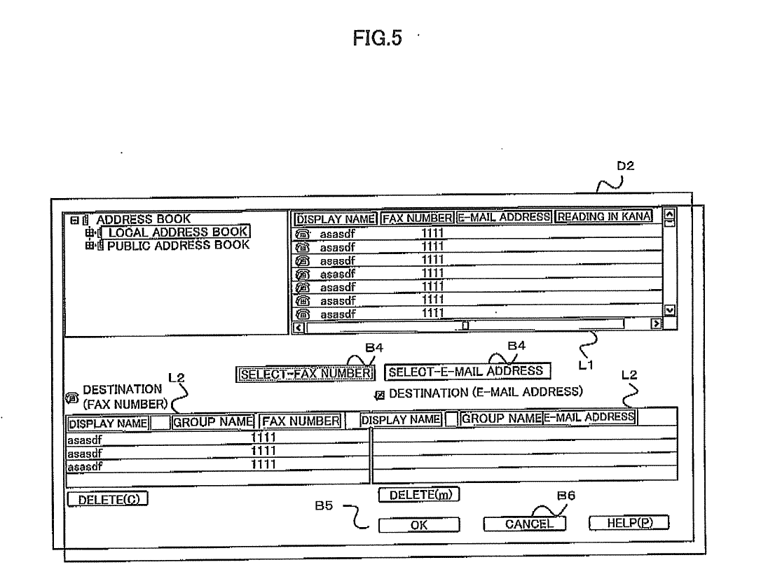

On the other hand, if information concerning a transmission destination is not set, i.e., if the property dialog is not displayed and a facsimile number or the like of the transmission destination is not set (Yes in ACT 3), the display unit 3 displays a destination designation dialog D2 shown in FIG. 5 (ACT 4).

The display unit 3 acquires an address list recorded in the HDD 16 in advance and displays the address list in a region in an upper section L1 of the destination designation dialog D2. The user selects transmission destinations from the address list displayed in the region L1 and presses a button B4 to set the transmission destinations. Information set as the transmission destinations is displayed in a region L2. If no transmission destination is set in the region L2, the display unit 3 disables an OK button B5. If one or more transmission destinations are set in the region L2, the display unit 3 enables the OK button B5. In this embodiment, in this way, the dialog including only the items related to the information concerning the transmission destinations is displayed. Setting items such as resolution other than the transmission destinations are not displayed. In this case, settings other than the transmission destinations are default settings.

The transmitting unit 4 determines whether facsimile transmission is performed, i.e., whether the OK button B5 of the destination designation dialog D2 is pressed (ACT 5). If the OK button B5 is pressed (Yes in ACT 5), the transmitting unit 4 outputs a facsimile transmission job to the MFP 200 (ACT 6). If a cancel button B6 is pressed (No in ACT 5), the processing returns to ACT 1.

When the MFP 200 is set as a default output destination apparatus, if the user clicks a printer icon on a tool bar of the application, an operation of ACT 4 is instantaneously performed.

If the information processing apparatus 100 itself can perform facsimile transmission not via the MFP 200, in ACT 6, the transmitting unit 4 directly transmits data to a facsimile apparatus of the transmission destination.

In the explanation of the example, in ACT 4, the information concerning the transmission destinations is selected from the address list. However, a method is also possible in which the display unit 3 displays a dialog for text input and the user directly inputs a facsimile number or the like when the user instructs transmission. The display unit 3 may display a dialog in which two forms, i.e., the selection from the address list and the direct input can be carried out.

In this embodiment, when the user transmits a facsimile job from the application via a facsimile driver, a dialog in which a destination can be designated is displayed only if a destination is not designated. The facsimile driver has a peculiar characteristic that only a transmission destination always needs to be designated despite the fact that most users do not use a function for setting resolution and other special functions. According to this embodiment, even if the property dialog cannot be opened in order to only designate a destination, the dialog in which a destination can be designated is displayed at timing when printing is started by the application. Therefore, convenience of use is substantially improved from an aspect of usability. The dialog including only the items related to the information concerning the transmission destinations without including other setting items is displayed. Therefore, the user can perform setting of a transmission destination with simple operation without being puzzled.

As explained above, according to this embodiment, it is possible to provide a technique for facilitating setting operation for destination designation and improving convenience of use when the user transmits a facsimile.

The processing explained with reference to FIG. 3 can be realized by causing the CPU 11 to execute the operation program stored in the HDD 16. A storage destination of the operation program is not limited to a HDD. For example, a RAM (Random Access Memory), a ROM (Read Only Memory), a DRAM, an SRAM (Static Random Access Memory), a VRAM (Video RAM), and a flash memory can be used.

### Other Embodiments

In general, according to another embodiment, an image forming apparatus with facsimile function includes: an image reading unit configured to optically read image information on an original document; an image forming unit configured to form an image on a sheet on the basis of image data read by the image reading unit; an acquiring unit configured to acquire instruction information for transmitting transmission target data by facsimile; a determining unit configured to determine, when the acquiring unit acquires the instruction information, whether information concerning a transmission destination is set; a display unit configured to display, if the determining unit determines that information concerning a transmission destination is not set, a dialog for causing a user to set a transmission destination, the dialog including only items relating to information concerning transmission destinations; and a transmitting unit configured to perform facsimile transmission on the basis of information concerning a transmission destination displayed on the dialog displayed by the display unit.

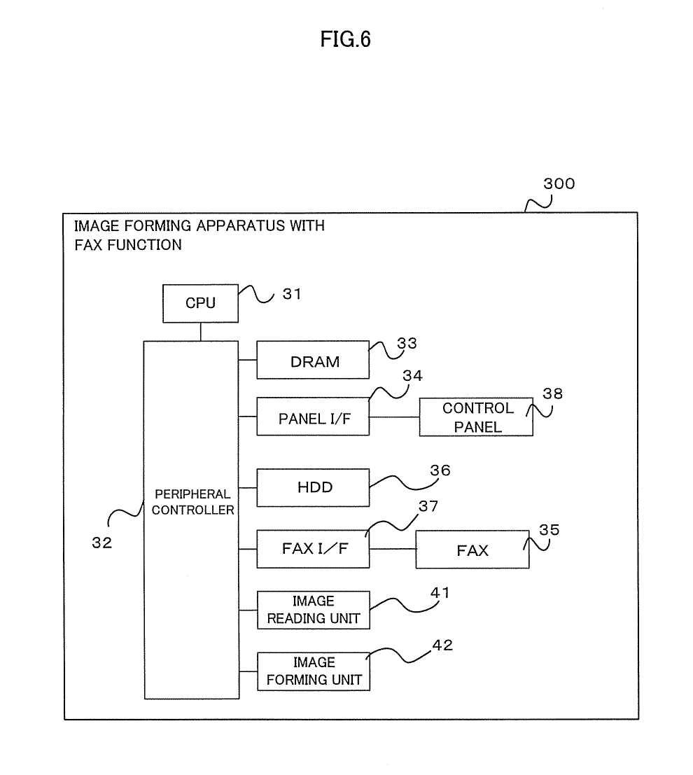

An example of a hardware configuration of an image forming apparatus with facsimile function necessary for carrying out this embodiment is shown in FIG. 6.

An operation program for an image forming apparatus with facsimile function 300 is stored in a HDD (Hard Disk Drive) 36. A CPU (Central Processing Unit) 31 decodes and executes the operation program to control the image forming apparatus with facsimile function 300. The CPU 31 performs, using a DRAM (Dynamic Random Access Memory) 33, an arithmetic operation for executing the operation program.

A control panel 38 is connected to various kinds of hardware of the image forming apparatus with facsimile function 300 via an I/F (Interface) 34.

A peripheral controller 32 executes control of these kinds of hardware and various I/O ports.

An image reading unit 41 includes an auto document feeder (ADF) configured to automatically convey an original document to a predetermined image reading position. The image reading unit 41 reads, with a scanning optical system, an image of an original document placed on a document tray (a predetermined document placing table) and automatically conveyed by the auto document feeder or an original document placed on a document table. Data read by the image reading unit 41 may be data for facsimile transmission.

An image forming unit 42 forms a developer image on a sheet on the basis of the image read from the original document by the image reading unit 41 or print data transmitted to the image forming apparatus with facsimile function 300 by an external apparatus. The image forming unit 42 includes a toner cartridge, a photoconductive member, a developing roller, a mixer, an intermediate transfer belt, a fixing device, and a discharge tray.

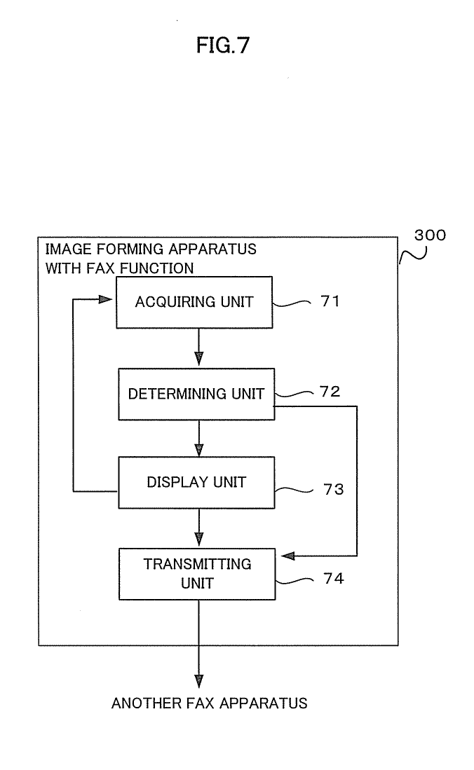

An example of functional blocks of the image forming apparatus with facsimile function 300 is shown in FIG. 7. The image forming apparatus with facsimile function 300 includes an acquiring unit 71, a determining unit 72, a display unit 73, and a transmitting unit 74.

The acquiring unit 71 acquires, via the control panel 38, instruction information output when electronic data is transmitted by facsimile. When the acquiring unit 71 acquires the instruction information, the determining unit 72 determines whether information concerning a transmission destination such as a facsimile number of the transmission destination is set (whether information concerning a transmission destination is stored in the DRAM 33 or the HDD 36 and this system can recognize the information).

The display unit 73 displays, on the control panel 38, document data or image data stored in the HDD 36 or the DRAM 33. If the determining unit 72 determines that information concerning a transmission destination of the facsimile is not set, the display unit 73 displays, on the control panel 38, a dialog for causing a user to set a transmission destination, which is a destination designation dialog including only items relating to information concerning transmission destinations.

The transmitting unit 74 transmits a facsimile transmission job including information concerning a transmission destination set via the dialog displayed by the display unit 73 and transmission target data to a facsimile apparatus of the transmission destination via a facsimile I/F 37.

A correspondence relation between the functional blocks shown in FIG. 7 and the hardware configuration shown in FIG. 6 is explained below. The acquiring unit 71 is realized by cooperation of the CPU 31, the peripheral controller 32, the panel I/F 34, the control panel 38, the operation program stored in the HDD 36, and the DRAM 33. The determining unit 72 is realized by cooperation of the CPU 31, the DRAM 33, the peripheral controller 32, and the operation program stored in the HDD 36. The display unit 73 is realized by cooperation of the CPU 31, the panel I/F 34, the control panel 38, the DRAM 33, the operation program stored in the HDD 36, and the peripheral controller 32.

The transmitting unit 74 is realized by cooperation of the CPU 31, the DRAM 33, the peripheral controller 32, the facsimile I/F 37, a facsimile 35, and the operation program stored in the HDD 36.

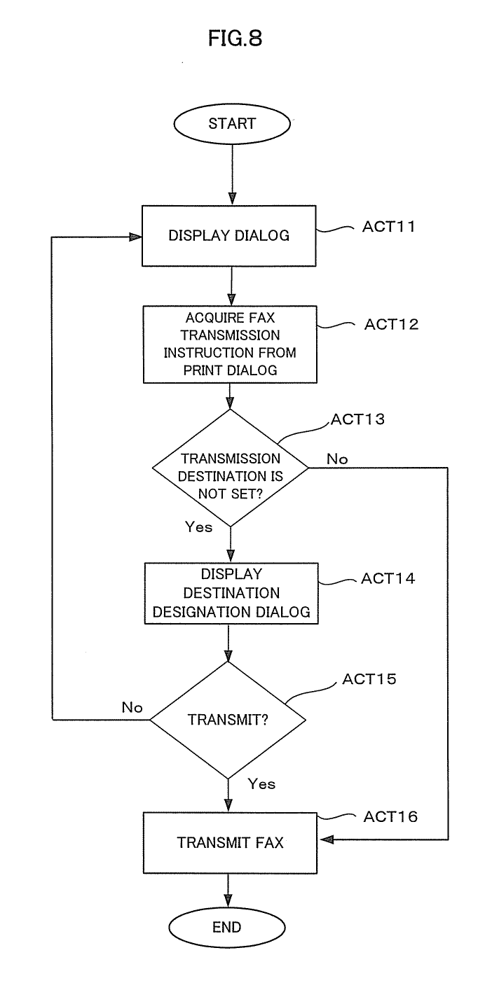

An operation example of the image forming apparatus with facsimile function 300 is explained below with reference to a flowchart of FIG. 8.

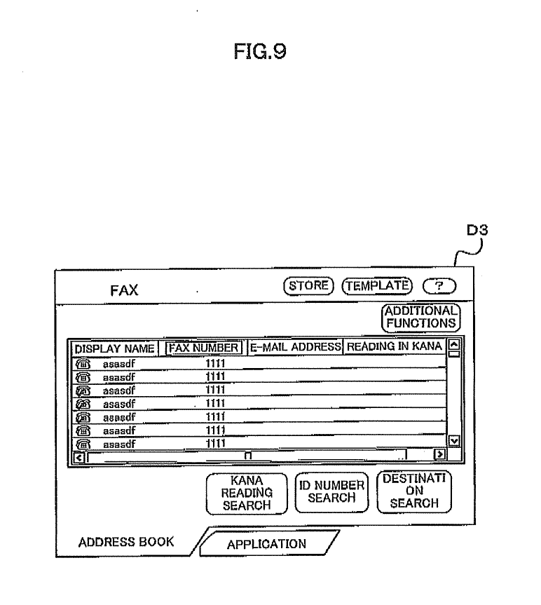

The display unit 73 displays a dialog D3 shown in FIG. 9 when a facsimile button is pressed (ACT 11). The dialog D3 is explained. Information concerning a transmission destination such as a facsimile number and an additional function button with which special functions such as a function for setting resolution can be set are displayed in the dialog D3.

Referring back to the flowchart of FIG. 8, when the user presses a start button of the dialog D3, the acquiring unit 71 acquires transmission instruction information (ACT 12).

When the acquiring unit 71 acquires the transmission instruction information, the determining unit 72 determines whether information concerning a transmission destination is set (ACT 13). If information concerning a transmission destination is set, i.e., if a facsimile number of the like of the transmission destination is set on the dialog D3 (No in ACT 13), the transmitting unit 74 transmits a facsimile to the set destination (ACT 16).

On the other hand, if information concerning a transmission destination is not set, i.e., if a facsimile number or the like of the transmission destination is not set (Yes in ACT 13), the display unit 73 displays the destination designation dialog D2 shown in FIG. 5 (ACT 14).

The display unit 73 acquires an address list recorded in the HDD 36 in advance and displays the address list in a region in the upper section L1 of the destination designation dialog D2. The user selects transmission destinations from the address list displayed in the region L1 and presses the button B4 to set the transmission destinations. Information set as the transmission destinations is displayed in the region L2. If no transmission destination is set in the region L2, the display unit 73 disables the OK button B5. If one or more transmission destinations are set, the display unit 73 enables the OK button B5. In this embodiment, in this way, the dialog including only the items related to the information concerning the transmission destinations is displayed. Setting items such as resolution other than the transmission destinations are not displayed. In this case, settings other than the transmission destinations are default settings.

The transmitting unit 74 determines whether facsimile transmission is performed, i.e., whether the OK button B5 of the destination designation dialog D2 is pressed (ACT 15). If the OK button B5 is pressed (Yes in ACT 15), the transmitting unit 74 outputs a facsimile to a designated transmission destination (ACT 16). If the cancel button B6 is pressed (No in ACT 15), the processing returns to ACT 11.

In the explanation of the example, in ACT 14, information concerning a transmission destination is selected from the address list. However, a method is also possible in which the display unit 73 displays a dialog for text input and the user directly inputs a facsimile number or the like when the user instructs transmission. The display unit 73 may display a dialog in which two forms, i.e., the selection from the address list and the direct input can be carried out.

In this embodiment, when the user transmits a facsimile, a dialog in which a destination can be designated is displayed only when a destination is not designated. The facsimile has a peculiar characteristic that only a transmission destination always needs to be designated despite the fact that most users do not use a function for setting resolution and other special functions. According to this embodiment, the dialog including only the items related to the information concerning the transmission destinations without including other setting items is displayed. Therefore, the user can perform setting of a transmission destination with simple operation without being puzzled.

As explained above, according to this embodiment, it is possible to provide a technique for facilitating setting operation for destination designation and improving convenience of use when the user transmits a facsimile.

The processing explained with reference to FIG. 8 can be realized by causing the CPU 31 to execute the operation program stored in the HDD 36. A storage destination of the operation program is not limited to a HDD. For example, a RAM (Random Access Memory), a ROM (Read Only Memory), a DRAM, an SRAM (Static Random Access Memory), a VRAM (Video RAM), and a flash memory can be used.

In the example explained above, the operation program for causing the CPU 31 to execute the processing in this embodiment is recorded in advance in the storage area provided in the image forming apparatus with facsimile function 300. However, the operation program may be downloaded from a network to the image forming apparatus with facsimile function 300. The operation program stored in a computer-readable recording medium may be installed in the image forming apparatus with facsimile function 300. The recording medium may be any recording medium as long as the recording medium can store the operation program and is computer-readable. Examples of the recording medium include an internal storage device internally mounted in a computer such as a ROM or a RAM, a portable recording medium such as a CD-ROM, a flexible disk, a DVD disk, a magneto-optical disk, or an IC card, a database that stores a computer program, another computer and a database of the computer, and a transmission medium on a line. Functions obtained by installation or download in advance may realize the functions in cooperation with an OS (Operating System) or the like in an apparatus. It is also possible to cause an ASIC to execute, in terms of a circuit, at least a part of processing realized by causing a CPU or a MPU to execute the operation program.

It is possible to carry out the present invention in other various forms without departing from the spirit or the main characteristics of the invention. Therefore, the embodiments explained above are merely illustrations in every aspect and should not be limitedly interpreted. The scope of the invention is indicated by the scope of claims and is by no means limited by the text of the specification. Further, all alterations, various improvements, substitutions, and modifications belonging to a range of a scope of equivalents of the scope of claims are within the scope of the invention.

What is claimed is:

1. An information processing apparatus comprising:
an acquiring unit configured to acquire instruction information for transmitting transmission target data by facsimile;
a determining unit configured to determine, when the acquiring unit acquires the instruction information, whether information concerning a transmission destination is set; and
a display unit configured to display, if the determining unit determines that information concerning a transmission destination is not set, a dialog for causing a user to set a transmission destination, the dialog including only items relating to information concerning transmission destinations.

2. The apparatus according to claim 1, wherein the display unit acquires, from a storing unit, a list of information concerning transmission destinations stored in the storing unit in advance and displays the list on the dialog.

3. The apparatus according to claim 1, further comprising a transmitting unit configured to transmit, to an apparatus having a facsimile transmission function, a transmission job including information concerning the transmission destination set via the dialog displayed by the display unit and the transmission target data.

4. The apparatus according to claim 2, further comprising a transmitting unit configured to transmit, to an apparatus having a facsimile transmission function, a transmission job including information concerning the transmission destination set via the dialog displayed by the display unit and the transmission target data.

5. The apparatus according to claim 4, wherein the apparatus having the facsimile transmission function includes an image reading unit configured to optically read image information on an original document and an image forming unit configured to form an image on a sheet on the basis of the image data read by the image reading unit.

6. The apparatus according to claim 1, further comprising a transmitting unit configured to transmit the transmission target data to an apparatus of the transmission destination set via the dialog displayed by the display unit.

7. The apparatus according to claim 2, further comprising a transmitting unit configured to transmit the transmission target data to an apparatus of the transmission destination set via the dialog displayed by the display unit.

8. An image forming apparatus with facsimile function comprising:
an image reading unit configured to optically read image information on an original document;
an image forming unit configured to form an image on a sheet on the basis of image data read by the image reading unit;
an acquiring unit configured to acquire instruction information for transmitting transmission target data by facsimile;
a determining unit configured to determine, when the acquiring unit acquires the instruction information, whether information concerning a transmission destination is set;
a display unit configured to display, if the determining unit determines that information concerning a transmission destination is not set, a dialog for causing a user to set a transmission destination, the dialog including only items relating to information concerning transmission destinations; and
a transmitting unit configured to perform facsimile transmission on the basis of information concerning a transmission destination displayed on the dialog displayed by the display unit.

9. The apparatus according to claim 8, wherein the display unit acquires, from a storing unit, a list of information concerning transmission destinations stored in the storing unit in advance and displays the list on the dialog.

10. The apparatus according to claim 8, wherein the display unit also functions as an input unit configured to input the instruction information.

11. A facsimile transmitting method comprising:
a computer acquiring instruction information for transmitting transmission target data by facsimile;
the computer determining, when instruction information is acquired, whether information concerning a transmission destination is set; and
the computer displaying, if the computer determines that information concerning a transmission destination is not set, a dialog for causing a user to set a transmission destination, the dialog including only items relating to information concerning transmission destinations.

12. The method according to claim 11, further comprising acquiring, from a storing unit, a list of information concerning transmission destinations stored in the storing unit in advance and displaying the list on the dialog.

13. The method according to claim 11, further comprising transmitting, to an apparatus having a facsimile transmission function, a transmission job including information concerning the transmission destination set via the displayed dialog and the transmission target data.

14. The method according to claim 12, further comprising a transmitting, to an apparatus having a facsimile transmission function, a transmission job including information concerning the transmission destination set via the displayed dialog and the transmission target data.

15. The method according to claim 14, wherein the apparatus having the facsimile transmission function includes an image reading unit configured to optically read image information on an original document and an image forming unit configured to form an image on a sheet on the basis of the image data read by the image reading unit.

16. The method according to claim 11, further comprising transmitting the transmission target data to an apparatus of the transmission destination set via the displayed dialog.

17. The method according to claim 12, further comprising transmitting the transmission target data to an apparatus of the transmission destination set via the displayed dialog.
